(19) United States
(12) Patent Application Publication
(10) Pub. No.: US 2013/0160270 A1
(43) Pub. Date: Jun. 27, 2013

(54) METHOD OF CONSTRUCTING RAISING WATER TANK FOR SEA FARMING

(71) Applicant: U Geun Park, Gangneung (KR)

(72) Inventor: U Geun Park, Gangneung (KR)

(21) Appl. No.: 13/712,902

(22) Filed: Dec. 12, 2012

(30) Foreign Application Priority Data
Dec. 21, 2011 (KR) 10-2011-0139189

(51) Int. Cl. A01K 61/00

(52) U.S. Cl. CPC A01K 61/00
USPC 29/428

(57) ABSTRACT

Disclosed are a raising water tank for sea farming, and a method of constructing a raising water tank for sea farming, which easily discharge foreign substances therefrom while being easily and conveniently carried and being simply repaired as well. The method includes setting a location of the raising water tank at a location where the raising water tank is to be installed; installing a discharge pipe an end of which is bent toward a bottom surface of the set raising water tank at a predetermined height from the bottom surface of the raising water tank such that the discharge pipe passes through a side surface of the raising water tank; and installing a suction member at a bent lower portion of the discharge pipe in the raising water tank such that the suction member contacts the bottom surface of the raising water tank.

### BACKGROUND OF THE INVENTION

1. Field of the Invention

The present invention relates to a raising water tank for sea farming, and more particularly to a method of constructing a raising water tank for sea farming which can easily discharge foreign substances therefrom while being easily and conveniently carried and being simply repaired as well.

2. Description of the Related Art

In general, since mother animals and larvae of fish and shellfish are subject to high stress due to a rapid change in water temperature, it is very important to maintain a proper water temperature and raise them in a precise environmental condition as well. The larvae (larvae of oysters, scallops, and shellfishes, children and fries of flatfishes and the like) are raised in the water while eating planktons until they become adult fishes, and are considerably sensitive to a temperature of the raising water.

Accordingly, raising water tanks for artificially isolating oceanic lives in a limited space and supplying them with artificial feed to raise them are being widely used. The raising water tanks for sea farming have been evolved in various forms, including those using concrete and those using fiber-reinforced plastic (FRP) or polypropylene (PP) used in recent years.

In addition, the raising water tank for sea farming should satisfy both a temperature of the raising water and a capability of efficiently discharging excrement of raised oceanic lives, that is, organic dregs in a short time.

That is, if foreign substances which are organic dregs are left alone for a long time in the raising water in the raising water tank, the foreign substances are solved in the water to deteriorate the quality of the raising water, which badly influences the raised oceanic lives. Thus, it is a considerably important key point to promptly discharge foreign substances such as organic dregs in the raising water tank.

In the raising water tank for sea farming of oceanic lives, a discharge pipe is installed under the ground on which the raising water tank is to be installed at a predetermined depth, an inlet is installed at an upper end of the discharge pipe, a bottom surface of the raising water tank is installed such that the inlet is located at a center of the raising water tank, and a side surface is installed at a periphery of the bottom surface to completely construct the raising water tank.

Next, a facility for maintaining a temperature of the raising water at a proper temperature is additionally installed to completely construct the raising water tank for sea farming.

However, in the raising water tank in which the discharge pipe is installed under the ground, the raising water tank is fixed so that there is a considerable troublesomeness of disassembling the entire raising water tank again, separating the discharge pipe connected to the raising water tank, and reconstructing the raising water tank when the raising water tank is to be moved if necessary.

Further, when water is leaked due to an abnormal state of the buried discharge pipe, the entire raising water tank should be disassembled and removed and the buried discharge pipe should be repaired, which is considerably troublesome and inconvenient.

Furthermore, since the raising water tank is fixed with no mobility, utilization of the space is restricted and space efficiency also significantly decreases.

In addition, above of all, since the inlet of the discharge pipe installed in the raising water tank for sea farming according to the related art is generally fixed to the center of the bottom surface of the raising water tank, foreign substances such as organic dregs located at a portion where the flow of the raising water is weak should be removed by a man power as they cannot be easily discharged.

### SUMMARY OF THE INVENTION

Accordingly, the present invention has been made keeping in mind the above problems occurring in the prior art, and an object of the present invention is to provide a method of constructing a raising water tank for sea farming which can easily discharge foreign substances therefrom while being easily and conveniently carried and being simply repaired as well.

Another object of the present invention is to maximize a discharge efficiency of foreign substances in a raising water tank.

A further object of the present invention is to smoothly discharge foreign substances located at a corner of a raising water tank.

A yet further object of the present invention is to manufacture a raising water tank of a lightweight and environment-friendly material.

In accordance with an aspect of the present invention, there is provided a method of constructing a raising water tank for sea farming, the method including: setting a location of the raising water tank at a location where the raising water tank is to be installed; installing a discharge pipe an end of which is bent toward a bottom surface of the set raising water tank at a predetermined height from the bottom surface of the raising water tank such that the discharge pipe passes through a side surface of the raising water tank; and installing a suction member at a bent lower portion of the discharge pipe in the raising water tank such that the suction member contacts the bottom surface of the raising water tank.

The suction member may be installed to be located a center of the bottom surface of the raising water tank.

The discharge pipe in the raising water tank may have a bending portion which is freely bent.

At least one suction member may be installed at a bent lower portion of the discharge pipe.

The raising water tank may be formed of a polypropylene resin.

According to the present invention, the raising water tank can be simply and conveniently moved and can be conveniently repaired. Further, the raising water tank can be easily moved and transported even after the construction of the raising water tank, so the space can be utilized maximally. The raising water tank can be smoothly repaired without troublesomeness or inconvenience and foreign substances can be smoothly discharged.

Further, since the discharge pipe can be moved leftward and rightward, foreign substances located at a corner of the raising water tank can be smoothly discharged. Thus, the raising water tank can be cleaned not manually but by using the discharge pipe.

Furthermore, since the discharge efficiency of the foreign substances in the raising water tank can be maximized, the raising water tank can be maintained more clearly.

In addition, since the raising water tank is manufactured of a lightweight and environment-friendly material, it can be conveniently manufactured and moved, and can be conveniently distributed as well.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a block diagram schematically showing a method of constructing a raising water tank for sea farming according to the present invention;

FIGS. 2A to 2C schematically show the method of constructing a raising water tank for sea farming according to the present invention, in which FIG. 2A is a diagram showing a step of setting a raising water tank, FIG. 2B is a diagram showing a discharge pipe installing step, and FIG. 2C is a diagram schematically showing a suction member installing step;

FIG. 3 is a diagram schematically showing another embodiment of the present invention; and

FIG. 4 is a diagram schematically showing a further embodiment of the present invention.

### DETAILED DESCRIPTION OF THE INVENTION

Hereinafter, exemplary embodiments of the present invention will be described in more detail with reference to the accompanying drawings.

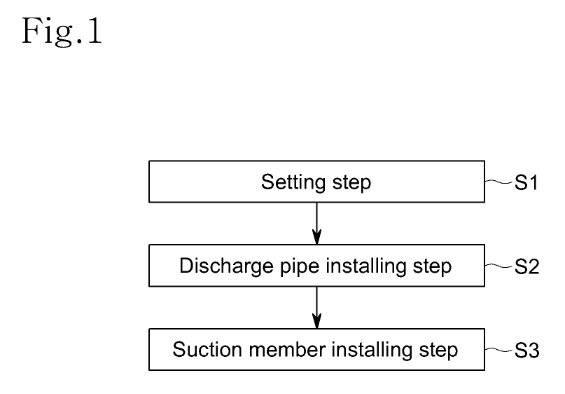

FIG. 1 is a block diagram schematically showing a method of constructing a raising water tank for sea farming according to the present invention.

As shown in FIG. 1, the present invention provides a method of constructing a raising water tank for sea farming which is adapted to raise various oceanic lives.

That is, the present invention relates to a method of constructing a raising water tank for sea farming which can easily discharge foreign substances therefrom while being easily and conveniently carried and being simply repaired as well.

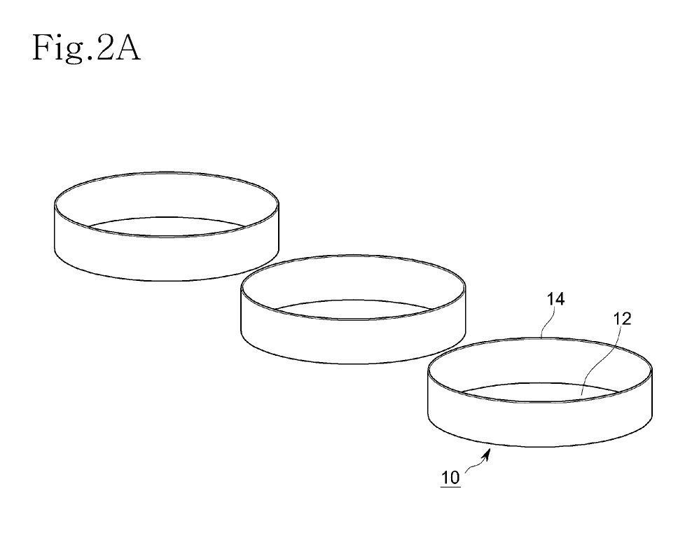

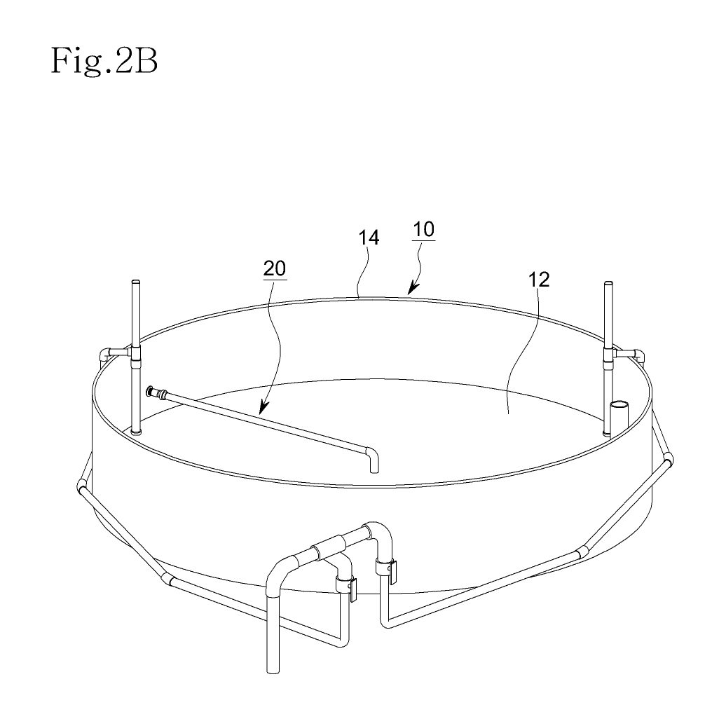

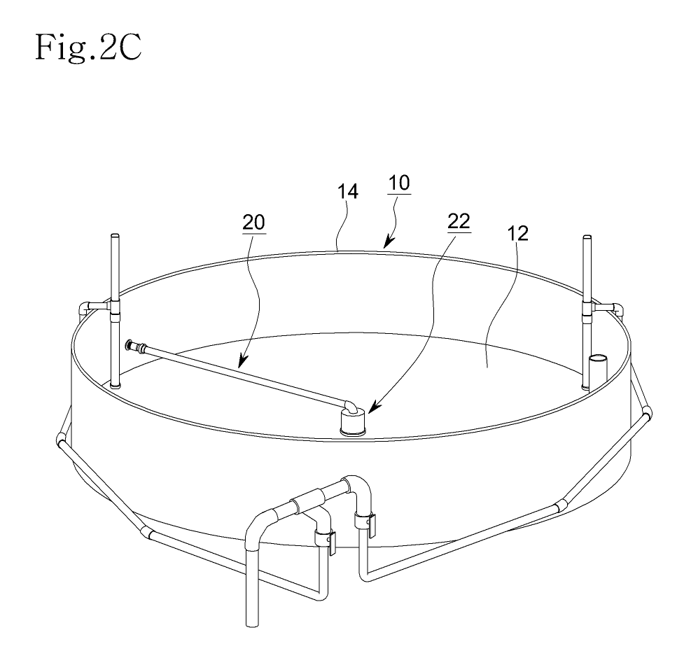

As shown in FIG. 2A, a setting step S1 of setting a location of a raising water tank 10 having a blocked bottom surface 12 and a side surface 14 such that raising water is filled therein and manufactured of environment-friendly and lightweight polypropylene at a location at which the raising water tank 10 is to be installed. Then, the location of the raising water tank 10 is preferably set such that a maximum number of raising water tanks can be installed according to a facility or space where the raising water tanks are to be installed.

In addition, since the material of the raising water tank is environment-friendly and lightweight, the raising water tank can be simply and conveniently carried or fed, and can be easily treated when the raising water tank is manufactured, making it possible to easily manufacture the raising water tank.

After the location of the raising water tank is set in this way, as shown in FIG. 2B, a discharge pipe installing step S2 of installing a discharge pipe 20 one end of which is bent toward the bottom surface 12 at a predetermined height from the bottom surface 12 of the raising water tank 10 such that the discharge pipe 20 passes through the side surface 14 of the raising water tank 10, the discharge pipe 20 not being installed under the ground, so that organic dregs which are excrement of oceanic lives is performed. Then, the side surface of the raising water tank through which the discharge pipe passes is processed to have a sealing property for preventing leakage of water through a general method. Further, foreign substances are discharged through the discharge pipe 20 not by using separate power but by using the known principle of siphon. That is, the discharge pipe is bent such that opposite sides thereof are different so that the raising water in the raising water tank can be pulled upward and then sent to a lower place due to a difference in atmospheric pressures.

Accordingly, since the discharge pipe installed in the raising water tank is not installed under the ground to be installed at a center of the bottom surface of the raising water tank but is installed to be exposed in the raising water tank, it can be promptly repaired when it is abnormal. Thus, a troublesomeness and an inconvenience of disassembling or removing the entire raising water tank due to a buried discharge pipe according to the related art can be solved.

Further, since the discharge pipe is installed so as not to be buried, the raising water tank can be easily carried or transported even while the discharge pipe is installed.

In addition, various general pipelines for circulating raising water in the raising water tank or maintaining temperature are preferably installed when the discharge pipe is installed. Next, as shown in FIG. 2C, a suction member installing step S3 of installing a general suction member 22 for suctioning organic dregs which are foreign substances generated when oceanic lives are raised at a bent lower portion of the discharge pipe 20 in the raising water tank 10 such that the suction member 22 contacts the bottom surface 12 of the raising water tank 10 is performed.

The suction member 22 is preferably installed at the center of the bottom surface 12 of the raising water tank 10 to uniformly suction foreign substances from the bottom surface of the raising water tank when the foreign substances are suctioned and discharged.

According to the present invention, the raising water tank can be simply and conveniently repaired with the discharge pipe not being disassembled or removed as in the related art due to a condition in which the raising water tank can be easily carried and transported, not by laying the discharge pipe underground for discharging foreign substances which are organic dregs produced when oceanic lives are raised but exposing the discharge pipe through the side surface of the raising water tank by using the known principle of siphon when the raising water tank is constructed.

In addition, since the raising water tank is manufactured of an environment-friendly and lightweight material, it can be conveniently distributed and manufactured and can be set at a desired accurate location with a minimum number of workers when the manufactured raising water tank is installed.

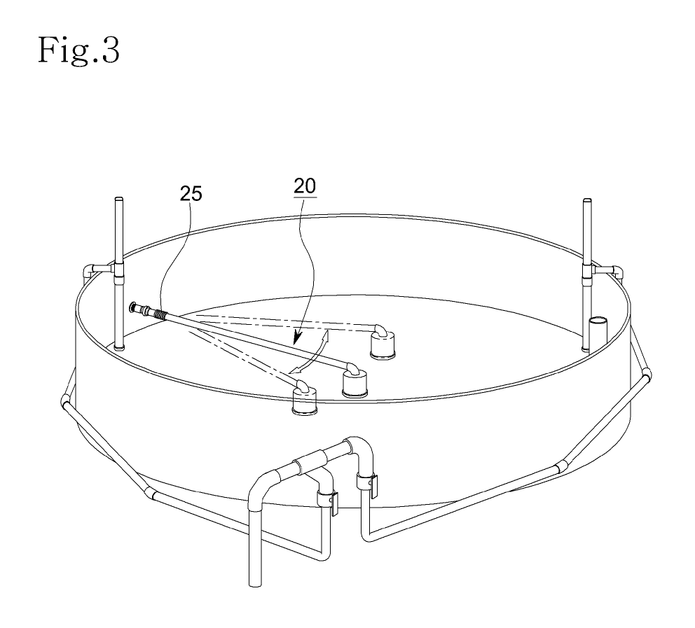

Meanwhile, as shown in FIG. 3, a bending portion 25 which can be freely bent so that foreign substances laid at a portion where the flow of the raising water in the raising water tank is weak are removed not manually but by moving the discharge pipe is formed in the discharge pipe 20 in the raising water tank 10.

That is, since a portion of the discharge pipe in the raising water tank is connected via a general flexible pipe or a soft synthetic resin pipe to have flexibility, the discharge pipe can be moved leftward and rightward about the bending portion so that the foreign substances laid at a portion where the flow of the raising water is weak can be removed not manually but by using the bending portion to move the discharge pipe itself.

Further, a rotation radius of the discharge pipe rotated leftward and rightward about the bending portion formed in the discharge pipe is preferably maximized by forming the bending portion at a location close to the side surface of the raising water tank.

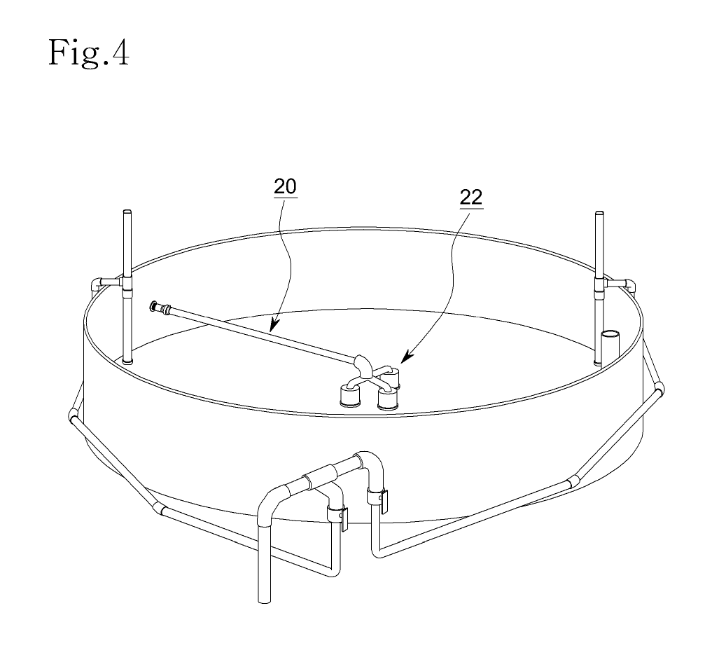

In addition, as shown in FIG. 4, since not only one but at least one suction member 22 is formed at the bent lower portion of the discharge pipe 20, a suction area of the suction member can be made maximally wide, making it possible to suction a more amount of foreign substances.

What is claimed is:

1. A method of constructing a raising water tank for sea farming, the method comprising:
setting a location of the raising water tank manufactured of polypropylene, which is environment-friendly and lightweight, on a ground surface on which the raising water tank is to be installed;
installing a discharge pipe an end of which is bent toward a bottom surface of the set raising water tank at a predetermined height from the bottom surface of the raising water tank such that the discharge pipe passes through a side surface of the raising water tank; and
installing a suction member at a bent lower portion of the discharge pipe in the raising water tank such that the suction member contacts the bottom surface of the raising water tank,
wherein the suction member is installed to be located a center of the bottom surface of the raising water tank, and the discharge pipe in the raising water tank has a bending portion which is freely bent.

2. The method as claimed in claim 1, wherein at least one suction member is installed at a bent lower portion of the discharge pipe.
